(19) United States
(12) Patent Application Publication
(10) Pub. No.: US 2010/0199531 A1
(43) Pub. Date: Aug. 12, 2010

(54) VISUAL TAG

(76) Inventors: STEVE BRETEY, Mason City, IA (US); Keith Kuhnly, Lino Lakes, MN (US); Larry Davis, Londsdale, MN (US)

Correspondence Address: STROOCK & STROOCK & LAVAN LLP, 180 MAIDEN LANE, NEW YORK, NY, 10038, US

(21) Appl. No.: 12/533,231

(22) Filed: Jul. 31, 2009

Related U.S. Application Data
(60) Provisional application No. 61/150,556, filed on Feb. 6, 2009.

(51) Int. Cl. G09F 3/00; G09F 3/02; G09F 3/04; G06K 19/06

(52) U.S. Cl. 40/301; 235/492

(57) ABSTRACT

An improved animal tag for application to an animal's ear which comprises a male portion that includes a flat segment and a projection segment, a female portion that includes a generally square or generally oval shaped flat segment and a raised segment with an aperture; wherein the projection segment of the male portion is adapted to be inserted through the animal's ear and into the aperture when pressure is applied thereto.

### CROSS-REFERENCE TO RELATED APPLICATION

This application claims the benefit of U.S. Provisional Application Ser. No. 61/150,556 filed Feb. 6, 2009, entitled “IMPROVED FEMALE SWINE VISUAL TAG” the entire disclosure of which is incorporated by reference herein.

### BACKGROUND OF THE INVENTION

1. Field of the Invention

The present invention relates generally to an improved visual tag for tracking animals and livestock.

2. Description of Related Art

Over the past few years, the identification or tagging of animals such as swine, cattle and other livestock at a farm or slaughter facility has become increasingly important. Producers and farmers typically tag such animals in order to maintain proper identification from birth through slaughter in order to track genetic performance and/or provide disease control. Traceability of these animals throughout the entire production cycle is critical to ensure a safe product is delivered to consumers and to easily track and/or isolate a problem if one arises in a product.

Plastic visual ear tags are the primary method of identifying swine today. These tags typically consist of two pieces; a male stud that is inserted through the animal's ear into another piece known as a female retaining tag. Currently, the primary tag used in swine, sheep or goat applications, for example, consists of a plastic male stud portion which consists of a pointed projection that is perpendicular to a flat piece of plastic and a female portion which currently is a round flat piece of plastic that has a raised circular portion with a hole therein to retain the male stud portion on the opposite side of the ear.

Typically the flat area on the male member holds the visual identification information (e.g., number). The shape of this flat identification area can be circular but is typically either square or rectangular to minimize the weight of the stud while maintaining the largest possible diameter (distance from each corner to the diagonally opposite corner) for the imprint area. This shape has proven to be very successful in the swine market especially when the tagging of these animals is completed on their day of birth as it is desirable for this tag to remain in the ear of each animal well into their processing at the packing facility.

In practice, the tag is applied to the animal's ear by driving the male stud through the animal's ear using an applicator or other similar instrument as is known in the art. The application of the tag creates a hole in the ear of the animal as the stud is pushed through the ear and connects with the female tag on the opposite side of the ear. Cattle and swine ears grow considerably from their birth until they are fully grown which causes this hole to increase in size during this time. Additionally, their ears are very thin when they are first born and the weight of an ear tag can also cause the initial hole to grow until the ear membrane thickens. Therefore, minimizing the weight of the tag helps to minimize the size of the hole in the animal's ear which improves the retention of the tag through the entire life span of the animal and the processing at a packing facility. At the same time, the diameter of the tag must be large enough to ensure that the tag is not pulled completely through the hole in the animal's ear which maximizes the tag's retention. Heretofore, the rounded shape of the female portion of the retaining tag has added to the tag's weight, created enlarged holes in the animal's ear and resulted in the loss or uselessness of many tags. Additionally, since the shape made in the animal ear is circular, it is easier for a circular female portion to slip through the hole which grows with the animal.

Therefore, a need exists for a tag that is designed to have a higher retention force.

### SUMMARY OF THE INVENTION

The present invention satisfies one or more of the foregoing and/or other deficiencies in the art. According to an embodiment of the present invention, an improved animal tag for application to an animal's ear is disclosed, the tag comprises a male portion that includes a flat segment and a projection segment, a female portion that includes a generally square shaped flat segment and a raised segment with an aperture; wherein the projection segment of the male portion is adapted to be inserted through the animal's ear and into the aperture when pressure is applied thereto.

In another embodiment, an improved animal tag for application to an animal's ear is disclosed, the tag comprises a male portion that includes a flat segment and a projection segment, a female portion that includes a generally oval shaped flat segment and a raised segment with an aperture; wherein the projection segment of the male portion is adapted to be inserted through the animal's ear and into the aperture when pressure is applied thereto.

### BRIEF DESCRIPTION OF THE DRAWINGS

A further understanding of the present invention can be obtained by reference to the embodiments set forth in the illustrations of the accompanying drawings. The drawings are not intended to limit the scope of this invention, but merely to clarify and be illustrative of embodiments of the invention.

FIG. 1 illustrates an assembled visual tag according to one embodiment of the present invention;

FIG. 2 illustrates a female portion of the visual tag of FIG. 1 according to one embodiment of the present invention;

FIG. 3 illustrates a male portion of the visual tag of FIG. 1 according to one embodiment of the present invention;

FIG. 4 illustrates an assembled visual tag according to one embodiment of the present invention;

FIG. 5 illustrates a female portion of the visual tag of FIG. 4 according to one embodiment of the present invention; and

FIG. 6 illustrates a male portion of the visual tag of FIG. 4 according to one embodiment of the present invention.

### DETAILED DESCRIPTION OF CERTAIN EMBODIMENTS

In general, the present invention relates to an improved visual tag for tracking animals and livestock. As described in greater detail below, and as will be appreciated by those skilled in the art, the size and shape of the tags disclosed in the various embodiments herein provide for an improved tag that minimizes the weight of the tag for an equivalent diameter and provides greater retention of the tag on the animal's ear.

As can be seen in FIGS. 1-3, according to one embodiment of the present invention the improved tag 100 comprises a male portion 102 and female portion 110. Male portion 102 preferably comprises a flat surface 104 and a projection member 106 that has a pointed tip portion 108 that can be inserted through the ear of an animal. Female portion 110 comprises a flat surface 112 and a circular protruding member 114 that has an aperture 116 that extends through both protruding member 114 and flat surface 112 for the insertion of projection 106 therethrough.

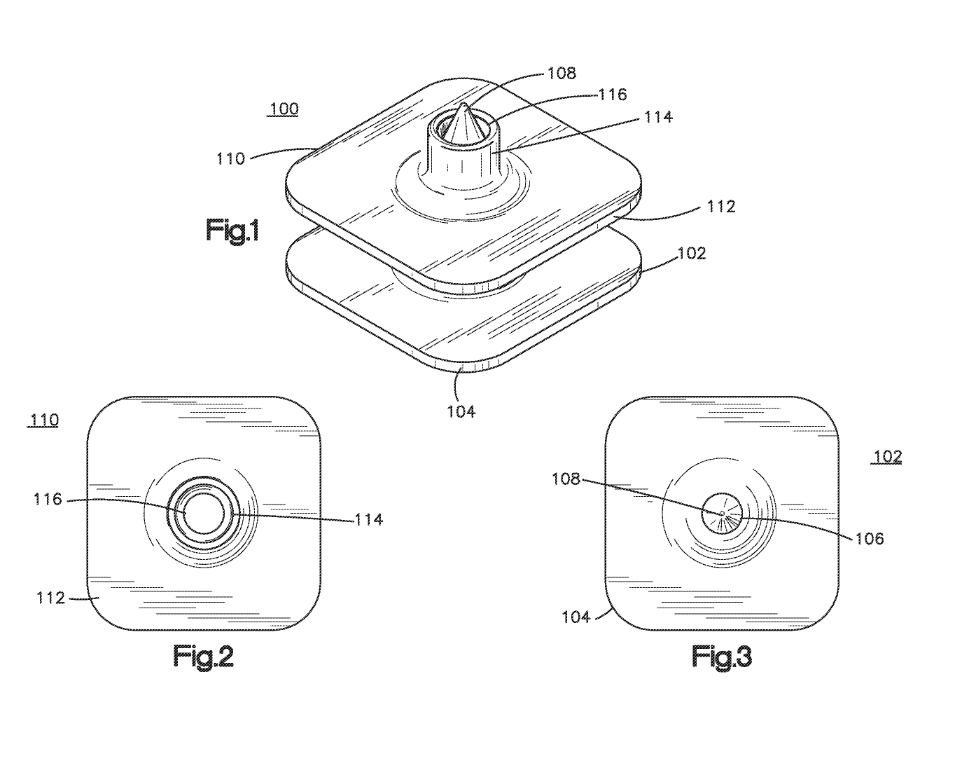

As can be seen in FIGS. 1 and 2, flat surface 112 is preferably square shaped or square-like to match the shape of flat surface 104 of male portion 102. This square or square like shape provides a larger diameter than a circular shaped surface while minimizing the tag 100's weight per diameter space. A square shape can provide for an increased diameter in both diagonals of the square. Because of its larger diameter and shape the square shaped flat surface 112 provides for longer retention of the tag when it is applied to the animal.

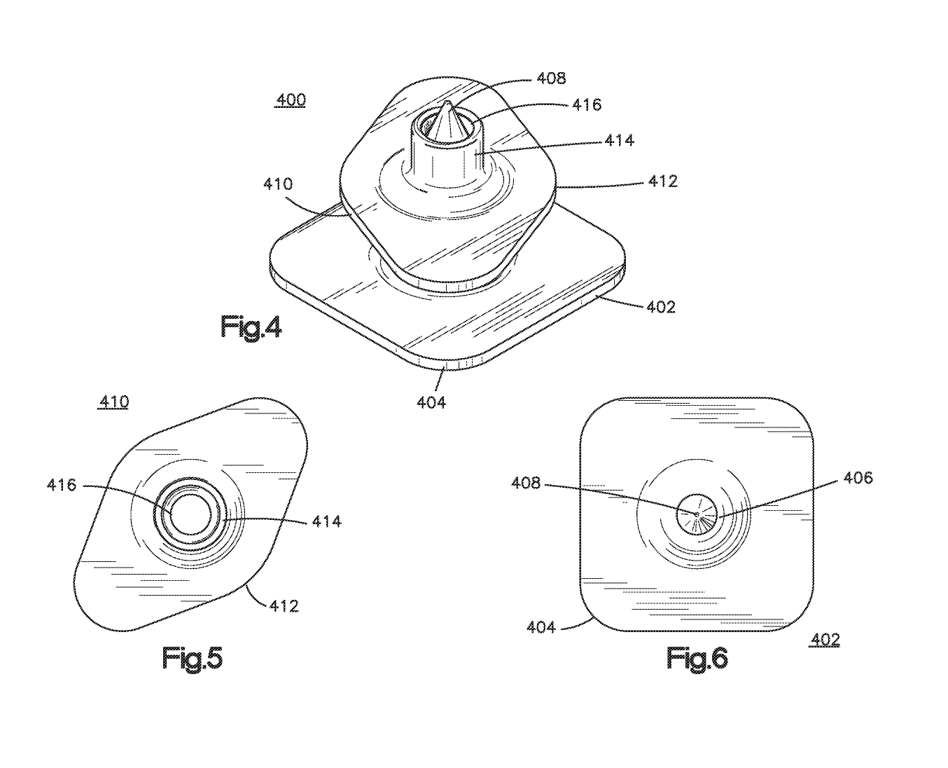

As can be seen in FIGS. 4-6, according to another embodiment of the present invention improved tag 400 comprises a male portion 402 and female portion 410. Male portion 402 preferably comprises a flat surface 404 and a projection 406 that has a pointed tip 408 that can be inserted through the ear of an animal. Female portion 410 comprises a generally oval or diamond shaped flat surface 412 and a circular protruding member 414 that has an aperture 416 that extends through both protruding member 414 and flat surface 412 for the insertion of projection 406 therethrough.

As can be seen in FIGS. 4-5, flat surface 412 is generally diamond or oval shaped to create a longer diameter from one side of the flat surface to the other. In contrast to the square shaped flat surface 112 which provides two diagonals with an increased diameter, the female portion of the present embodiment includes an increased diameter across the length of the flat surface which comprises an oblong shape. This diamond or oblong shape is inherently lighter in weight for a square or circular shape with an identical diameter. The oval or oblong shape also reduces the size of the square or square like shape and provides a larger diameter than a circular shaped surface while minimizing the tag's weight. A tag with a larger diameter tag is particularly beneficial because it provides increased area for identification information, and therefore having a tag that has an equivalent diameter and decreased weight increase its utility as well as its longevity. Moreover, since the shape of the hole in the animal's ear is typically round, the non-circular shape is less likely to pull through the round hole.

In practice, the tag is applied to the animals ear by driving the male projection through the animal's ear into the female portion by using an applicator or other similar instrument as is known in the art.

As is known in the art, animal tags can be manufactured in both tamper evident and non-tamper evident designs. Typically in a tamper evident tag, a cover and/or locking mechanism is included as part of the female portion when the tag is molded or manufactured. In a non tamper evident tag when one wants to separate a previously joined male and female portion, the projection of the male portion is cut and remaining tip can be pushed out of the female portion making the tag usable again. In a tamper evident tag, once the tip is inserted through the female protruding member and into the cover or locking mechanism, the tip of the projection on the male portion cannot be removed from the female portion. Thus, making the tag unusable with a new male portion. The improvements of the tags described herein can be applied to both types of tags. In certain embodiments, the shape of the flat surface of the female portion can differ based on the various designs and can be shaped or molded to match any particular tag design. Additionally, in one embodiment, the improved tag may be part of a Radio-Frequency-Identification (“RFID”) tag or other tags as are used in the art.

The improved tags disclosed herein may be manufactured by any suitable technique as is known in the art using any suitable material although a plastic material such as polyurethane may be particularly suitable. The entire tag may be made out of a single material or different materials. For example, a more or less pliable material may be used if it is necessary to make a certain portion of the tag more or less rigid for any reason.

Although as one skilled in the art can appreciate the tags and the components thereof can be made in any suitable size, in a preferred embodiment of tag 100, portion 102 has a width between 1.0 and 1.4 inches and a length between 1.0 and 1.4 inches. Preferably flat surface 112 has a thickness that does not exceed 0.5 inches, circular protruding member 114 has a height above flat surface 112 between 0.25 and 0.5 inches and a radius between 0.25 and 0.45 inches. In a preferred embodiment of tag 400, portion 402 has a length between 1.25 and 1.6 inches and a width between 0.8 and 1.1 inches. Preferably flat surface 412 has a thickness not to exceed 0.5 inches, circular protruding member 414 has a height above flat surface 412 between 0.3 and 0.6 inches, and a radius between 0.25 and 0.45 inches. In one embodiment, portion 102 or 402 has a slightly inclined portion that connects the flat surface and circular protruding member. This inclined portion preferably does not exceed 0.15 inches in height.

In testing the tags of the embodiments described herein it has been determined that the improved tags are longer lasting than prior art tags which utilize a circular shaped female portion. For example, in conducting an experiment of the improved tag, 4 groups of 500 swine were tagged at birth with a tag on each ear. One tag was a prior art tag with a circular shaped female portion and the other was a tag with an oval or square shaped female tag as described herein. The double tagged animals which were born roughly over a one-month period were carried through the typical production process including the slaughtering of the animal and passing it through a scald tank and dehairing machine as is known in the art. The animals were harvested over an eight week period and reviewed to see if their tags remain intact and attached to the animal. At the end of the eight week period the following results were realized:

Swine Tested

| | Group A | Group B | Group C | Group D |
|---|---|---|---|---|
| | Oval on | Square on | Circle on | Circle on |
| | Left Ear | Left Ear | Left Ear | Left Ear |
| | and | and | and | and |
| | Circle on | Circle on | Oval on | Square on |
| | Right Ear | Right Ear | Right Ear | Right Ear |
| Week 1 | 66 | 1 | 0 | 0 |
| Week 2 | 70 | 0 | 0 | 0 |
| Week 3 | 87 | 61 | 0 | 0 |
| Week 4 | 67 | 97 | 51 | 0 |
| Week 5 | 48 | 144 | 150 | 72 |
| Week 6 | 5 | 37 | 59 | 145 |
| Week 7 | 0 | 3 | 65 | 133 |
| Week 8 | 0 | 0 | 5 | 27 |
| Total | 343 | 343 | 330 | 377 |

* If both tags fell off the animal was unidentifiable and not included in the totals.

Tags loss

| | Group A | | Group B | | Group C | | Group D | |
|---|---|---|---|---|---|---|---|---|
| | Oval L. | Circle R. | Square L. | Circle R. | Circle L. | Oval R. | Circle L. | Square R. |
| Week 1 | 3 | 5 | 1 | 0 | 0 | 0 | 0 | 0 |
| Week 2 | 2 | 7 | 0 | 0 | 0 | 0 | 0 | 0 |
| Week 3 | 6 | 9 | 5 | 9 | 0 | 0 | 0 | 0 |
| Week 4 | 2 | 5 | 8 | 8 | 6 | 12 | 0 | 0 |
| Week 5 | 1 | 4 | 12 | 29 | 23 | 21 | 0 | 2 |
| Week 6 | 1 | 1 | 1 | 4 | 5 | 11 | 19 | 11 |
| Week 7 | 0 | 0 | 0 | 0 | 6 | 3 | 10 | 6 |
| Week 8 | 0 | 0 | 0 | 0 | 0 | 0 | 8 | 4 |
| Total | 15 | 31 | 27 | 50 | 40 | 47 | 37 | 23 |

Based on the data above, it is clear that the prior art tag maintains the least retention over the course of the production process. A raw analysis based on the data culled from the experiment, indicates that 11.3% of the prior art tag with the circular shaped female portion were lost during the experiment. In contrast, only 9.2% of the oval shaped tags and 6.9% of the square shaped tags were lost. It is therefore apparent that the improved tags discussed herein improve the retention of such tags over a longer period of time. Using statistical analysis software as is known in the art to generate the “Least Square Mean” and create a weighted mean and weighted probability of the above results yields the following:

Least Square Means based on tag type

| Tag type | Mean | Standard Error |
|---|---|---|
| Circle | 10.21% | 1.83% |
| Oval | 8.61% | 1.83% |
| Square | 5.90% | 1.37% |

Difference of Least Square Means based on tag type

| Tag type | Tag type | Probability | Analysis |
|---|---|---|---|
| Circle | Oval | 0.2883 | 29% due to chance, |
| | | | 71% due to difference |
| Circle | Square | 0.0012 | 0.1% due to chance, |
| | | | 99.9% due to difference |
| Oval | Square | 0.0994 | 10% due to chance, |
| | | | 90% due to difference |

Hence using the improved tags described herein results in improved tracking of livestock and increased longevity of the tag over the course of the livestock's production.

It should be noted that although the device described above is described in terms of specific materials, shapes and sizes other embodiments of the present invention could be implemented using different materials, shapes and sizes. For example, although certain of the embodiments have been described herein as being in a square or oval shape, additional shapes including but not limited to stars, pentagrams or octagon configurations can be used to increase diameter size and reduce weight. Moreover although described as a multi-part tag, the various elements of the tags can each be used individually, in combination with each other or in combination with other devices or elements. The precise design and method of manufacturing the tag may be altered and remain within the scope of the present invention. Those skilled in the art recognize that the present invention has many applications, may be implemented in many manners and, as such, is not to be limited by the foregoing exemplary embodiments and examples. In this regard, any number of the features of the different embodiments described herein may be combined into one single embodiment. Moreover, the scope of the present invention covers conventionally known and future developed variations and modifications to the tag and components described above as would be understood by those skilled in the art. It is the intention, therefore, to be limited only as indicated by the scope of the claims appended hereto.

It is also to be understood that the following claims are intended to cover all of the generic and specific features of the invention herein described and all statements of the scope of the invention, which, as a matter of language, might be said to fall therebetween.

1. An improved animal tag for application to an animal's ear comprising:
a male portion that comprises a flat segment and a projection segment;
a female portion that comprises a generally square-shaped flat segment and a raised segment with an aperture;
wherein the projection segment of the male portion is adapted to be inserted through the animal's ear and into the aperture when pressure is applied thereto.

2. The tag of claim 1 wherein the projection segment contains a pointed tip at its distal end.

3. The tag of claim 1 further comprising an inclined portion between the flat segment and raised segment.

4. The tag of claim 1 wherein the raised segment is circular and protrudes between 0.25 and 0.5 inches above the flat segment of the female portion.

5. The tag of claim 1 wherein the flat segment of the male portion is generally square shaped.

6. The tag of claim 1 wherein the flat segment of the male portion is generally circular shaped.

7. The tag of claim 1 wherein the female portion further comprises a tamper resistant cover.

8. The tag of claim 1 wherein the tag is an RFID tag.

9. An improved animal tag for application to an animal's ear comprising:
a male portion that comprises a flat segment and a projection segment;
a female portion that comprises a generally oval shaped flat segment and a raised segment with an aperture;
wherein the projection segment of the male portion is adapted to be inserted through the animal's ear and into the aperture when pressure is applied thereto.

10. The tag of claim 9 wherein the projection segment contains a pointed tip at its distal end.

11. The tag of claim 9 further comprising an inclined portion between the flat segment and raised segment.

12. The tag of claim 9 wherein the raised segment is circular and protrudes between 0.25 and 0.5 inches above the flat segment of the female portion.

13. The tag of claim 9 wherein the flat segment of the male portion is generally rectangular shaped.

14. The tag of claim 9 wherein the flat segment of the male portion is generally circular shaped.

15. The tag of claim 9 wherein the female portion further comprises a tamper resistant cover.

16. The tag of claim 9 wherein the tag is an RFID tag.

17. An improved animal tag for application to an animal's ear comprising:
a male portion that comprises a flat segment and a projection segment;
a female portion that comprises a non-circular flat segment and a raised segment with an aperture;
wherein the projection segment of the male portion is adapted to be inserted through the animal's ear and into the aperture when pressure is applied thereto.

18. The tag of claim 17 wherein the flat segment of the female portion is generally pentagram shaped.

19. The tag of claim 17 wherein the flat segment of the female portion is generally octagon shaped.

20. The tag of claim 17 wherein the flat segment of the female portion is generally star shaped.
